(19) United States
(12) Patent Application Publication
(10) Pub. No.: US 2008/0045868 A1
(43) Pub. Date: Feb. 21, 2008

(54) SELF-RETAINED HEMORRHOID MASSAGE DEVICE

(76) Inventor: Jiro TAKASHIMA, Houston, TX (US)

Correspondence Address: EGBERT LAW OFFICES, 412 MAIN STREET, 7TH FLOOR, HOUSTON, TX, 77002, US

(21) Appl. No.: 11/871,891

(22) Filed: Oct. 12, 2007

Related U.S. Application Data
(63) Continuation-in-part of application No. 11/452,628, filed on Jun. 15, 2006.

(51) Int. Cl. A61H 1/00

(52) U.S. Cl. 601/46

(57) ABSTRACT

A self retained hemorrhoid massage device for use in an anal canal has a shaft and ring positioned on the shaft between the first end and the second end of the shaft. The ring extends outwardly of the shaft and has a diameter of between 4 and 14 millimeters. The shaft has a length between the outermost diameter of the ring and either end of the shaft of 1.5 cm. The shaft and the ring are preferably integrally formed together. The diameter of the shaft is, preferably, between ⅓ and ⅔ of a maximum diameter of the ring.

### CROSS-REFERENCE TO RELATED APPLICATIONS

The present application is a continuation-in-part of U.S. patent application Ser. No. 11/452,628, filed on 15 Jun. 2006, and entitled “Suppository for Hemorrhoid Treatment”, presently pending.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

1. Field of the Invention

The present invention relates to hemorrhoid massage devices. More particularly, the present invention relates to devices used for hemorrhoid treatment and designed to stay within the anal canal. The device moves up and down within the anal canal in order to massage internal and external hemorrhoids.

2. Description of Related Art Including Information Disclosed Under 37 CFR 1.97 and 37 CFR 1.98.

Most hemorrhoid massage devices have a tapered face and the conical face. Most of the tapered face is positioned within the rectum, and a portion of the conical face is outside the anus. The lower portion of the tapered face and the upper portion of the conical face are in the anal canal at a balanced position.

The device moves slightly upward and downward by changing conditions, such as spasms and peristaltic movement within the anal canal.

U.S. Pat. No. 3,777,755, issued to Groves on Dec. 11, 1973, discloses a suppository. Unlike other suppositories, the suppository of the Groves patent stays within the anal canal without ascending to the rectum. The suppository is removed by pulling the suppository from the anus manually. The Grove patent consists of two bulbs connected by a thin flexible shaft. One bulb stays within the rectum, and the other bulb stays outside of the anus to securely stride the anal canal.

Most hemorrhoid suppositories having a bullet shape. It is quite difficult for these bullet-shaped suppositories to stay within the anal canal after they are inserted. These bullet-shaped suppositories tend to go upwardly into the rectum before any medication on the suppository could be directly applied to the internal hemorrhoid area.

U.S. Pat. No. 4,563,182, issued to Stoy et al. on Jan. 7, 1986 discloses a device with two collars 114 and 130 attached on the shaft. The forward collar 114 has a conical forward face to facilitate passage of the forward collar 114 through the sphincter muscle. The rearward face 118 reduces the likelihood of device being expelled outwardly through the sphincter. The rearward collar 130 has a forward buffer face 132 and a rearward face 134. The sole purpose of the rearward collar 130 is to act as a stopper, preventing the passage of the entire device through the sphincter muscle. The rearward collar 130 of the stopper can be a manual holding section 140.

From the detailed explanation of the invention above, the anal sphincter supposedly grips the device at the cylindrical mid-section 120 between the rearward face 118 of the forward collar 114 and the portion of the forward buffer face 132 of the rearward collar 130. However, the conical forward face of the forward collar 114 and the forward buffer face 132 will push the device out of the sphincter. The upper edge of the sphincter, contacting the rearward face 118 of the forward collar 114, is soft and flexible. The forward buffer face 132 of the collar 130 will be pushed out by the lateral pressure of the anal sphincter. Additionally, the central portion of the anal sphincter grips the forward collar 114, so the conical forward face of the collar 114 and the forward buffer face 132 of the collar 130 will still push out the device easily. Thus the device of the Stoy patent is never be able to stay within the anal canal by itself because of the interaction of the structures and the anal sphincter.

It is an object of the present invention to provide a self retained hemorrhoid massage device movably retained within the anal canal. The device utilizes the self-cleaning activity of the anal canal in order to avoid entering the rectum and being expelled from the anus.

It is another object of the present invention to provide a self retained hemorrhoid massage device that particularly adapted to the size and structure of the anal canal.

It is further object of the present invention to provide a self retained hemorrhoid massage device that is easy to use, easy to manufacture and relatively inexpensive.

These and other objects and advantages of the present invention will become apparent from a reading of the attached specification and appended claims.

### BRIEF SUMMARY OF THE INVENTION

The present invention is a self-retained hemorrhoid massage device for use in an anal canal. The device includes a shaft having a first end and a second end, and a ring formed on the shaft between the first end and the second end. The ring extends outwardly of the shaft and has a diameter greater than the diameter of the shaft. In the present invention, the shaft is generally cylindrical. In particular, the shaft has a length of no less than 3 centimeters. The minimum length of the widest portion of the ring to either end of the shaft is approximately 15 millimeters. The ring will have a diameter of approximately between 4 and 14 millimeters inclusive. While the optimum diameter of the ring is between 6 and 12 millimeters inclusive. Additionally, the ring has a thickness of no less than the diameter of the widest portion of the ring. The diameter of the shaft is approximately between ⅓ and ⅔ of the diameter of the ring.

### BRIEF DESCRIPTION OF THE SEVERAL VIEWS OF THE DRAWINGS

FIG. 1 is a side elevation view of the self retained hemorrhoid massage device of the present invention.

FIG. 2 is another side elevation view of the self retained hemorrhoid massage device of the present invention.

FIG. 3 is a top view of the self-retaining hemorrhoid massage device of the present invention.

### DETAILED DESCRIPTION OF THE INVENTION

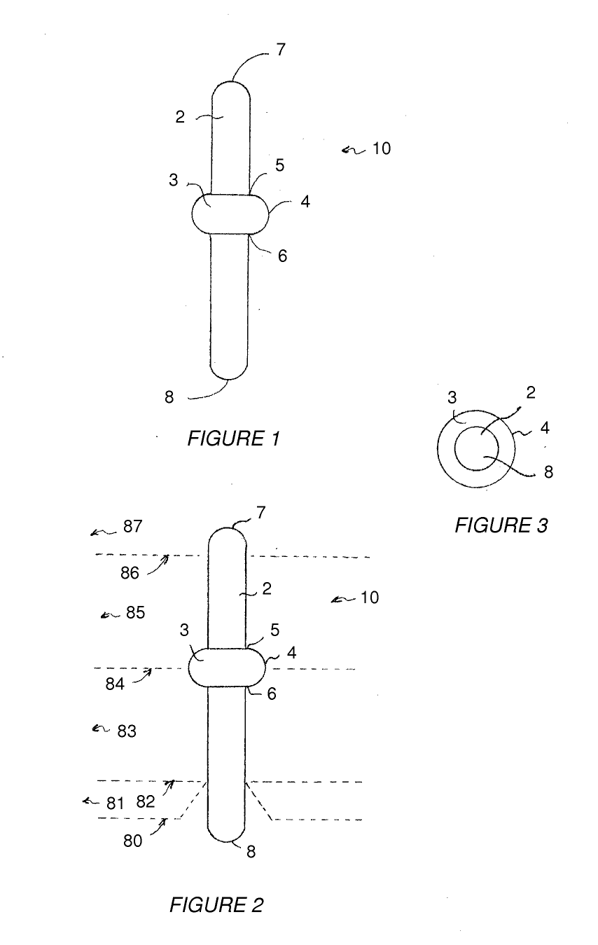

FIG. 1 shows the self-retained hemorrhoid massage device 10 of the present invention suitable for use in hemorrhoid treatment. The self-retained hemorrhoid massage device 10 of the present invention has a shaft 2 with a ring 3 formed thereon. The ring 3 is formed between ends 7 and 8 of the shaft 2. The shaft 2 has a generally cylindrical shape between the ends 7 and 8. The ring 3 and the shaft 2 are formed of solid or flexible materials. Additionally, the ring 3 and the shaft 2 may have a medication material that is suitably dissolvable when received within the anal canal. The ring 3 extends axially outwardly of the shaft 2 and has a diameter that is approximately between 1.5 to 3 times greater than the diameter of the shaft 2.

The ring 3 has a generally half round shape. In other words, the outermost periphery of the ring 3 is suitably curved so as to smoothly conform to the dentate line of the anal canal. The top 5 and the bottom 6 of the ring 3 have a generally planar structure extending radially outwardly of the shaft 2. The ring 3 has a widest portion 4. This widest portion 4 has a diameter between 4 millimeters and 14 millimeters, while the optimum diameter is between 6 millimeters and 12 millimeters. The thickness of the ring 3 between the top 5 and the bottom 6 is no more than the widest portion 4 of the ring 3.

The top end 7 of the shaft 2 has a dome shape. Similarly, the bottom end 8 of the shaft 2 has a dome shape. The minimum length of the shaft 2 between the top end 7 and the bottom end 8 is 3 centimeters while the optimum length is between 4 centimeters and 5 cm inclusive. The minimum length from the wide portion 4 of the ring 3 to either end of the shaft is approximately 1.5 centimeters.

The foregoing disclosure and description of the invention is illustrative and explanatory thereof. Various changes in the details of the illustrated construction can be made within the scope of the appended claims without departing from the true spirit of the invention. The present invention should only be limited by the following claims and their legal equivalents.

I claim:

1. A self retained hemorrhoid massage device comprising:
a shaft having a first end and a second end, said shaft being a generally cylindrical;
a ring affixed on said shaft between said first end and said second end, said ring axial extending from said shaft, said ring having an outermost diameter of approximately between 4 millimeters and 14 millimeters inclusive, said shaft having a length between said first end and said second end of no less than approximately 3 centimeters, said shaft having a length between said outermost diameter of said ring to either end of said shaft of 1.5 cm, said shaft having a diameter between ⅓ and ⅔ of said outermost diameter of said ring.
